(19) United States
(12) Patent Application Publication
(10) Pub. No.: US 2015/0166363 A1
(43) Pub. Date: Jun. 18, 2015

(54) METHODS AND SYSTEMS FOR WATER RECOVERY

(71) Applicant: SOLEX WATER LTD., Gizo (IL)

(72) Inventors: Aharon Eyal, Jerusalem (IL); Carmi Raz, Gizo (IL)

(21) Appl. No.: 14/402,918

(22) PCT Filed: May 19, 2013
(86) PCT No.: PCT/IB2013/054110

§ 371 Date: Nov. 21, 2014

Related U.S. Application Data
(60) Provisional application No. 61/815,283, filed on Apr. 24, 2013.
(60) Provisional application No. 61/754,980, filed on Jan. 22, 2013.
(60) Provisional application No. 61/649,728, filed on May 21, 2012.

(51) Int. Cl. C02F 1/26; C02F 1/44

(52) U.S. Cl. CPC C02F 1/26; C02F 1/441; C02F 2101/345

(57) ABSTRACT

Disclosed are methods comprising: (a) first contacting at least a portion of a wastewater stream comprising one or more hydrophilic solutes and one or more crude-oil-associated hydrophobic solutes with an extractant comprising a bi-directional solvent at a first temperature (T1) within 40° C. of the solvent-water critical temperature to form a water-depleted first aqueous solution and a water-enriched first contacting first organic phase; (b) adjusting the temperature of said first organic phase to a second temperature (T2), to form a second organic phase and a second aqueous solution; wherein the absolute value of (T2−T1) is at least 20; (c) separating at least a portion of said one or more crude-oil-associated hydrophobic solutes from said second organic phase; and (d) recycling bi-directional solvent from said second organic phase to said first contacting. Disclosed are also systems.

### RELATED APPLICATIONS

The present application gains priority from U.S. Provisional Patent Applications:

U.S. 61/649,728 filed on 21 May 2012 by Aharon Eyal and entitled “METHODS AND SYSTEMS FOR WATER RECOVERY”;

U.S. 61/754,980 filed on 22 Jan. 2013 by Aharon Eyal and entitled “METHODS AND SYSTEMS FOR WATER RECOVERY”; and

U.S. 61/815,283 filed on 24 Apr. 2013 by Aharon Eyal and entitled “METHODS AND SYSTEMS FOR WATER RECOVERY”; each of which is fully incorporated herein by reference.

### FIELD AND BACKGROUND OF THE INVENTION

The invention is in the field of water treatment. Water, like many other natural resources, is present on earth in a finite amount. More than 95% of the water on Earth is present as brackish water or sea water containing a salt concentration which renders it unsuitable for many purposes.

It is estimated that more than two thirds of the remaining non-salty water is present as ice, primarily in polar caps and glaciers.

This means less than 1% of the water on earth is available as fresh water.

This small fraction of fresh water must sustain not only life, but industry. Although the demand for potable water increases with the world's population, direct consumption of water by man (i.e. drinking water) and indirect consumption by man (e.g. bathing, laundry, in sanitary installations) makes up a relatively small percentage of total water consumption in the world.

The bulk of total water consumption in the world is in industrial processes, including use as a cooling medium.

For example, The National Energy Board of Canada (2006) estimated that about 2 to 4.5 barrels of fresh water are used to produce a barrel of synthetic crude oil. Total water consumption for production of synthetic crude was projected to reach 529 million cubic meters/year. Wastewater from synthetic crude oil production is alkaline, and brackish.

Induced hydraulic fracturing (A.K.A. fracking) for production of natural gas and other petrochemicals from shale also consumes significant amounts of water. It is estimated that 20 to more than 70% of fracking water is recovered either as flow-back water or as produced water.

In the state of Pennsylvania alone the amount of high-TDS (total dissolved solids) wastewater produced by fracking and needing disposal was projected to reach to 7300 million gallons per year in 2011 by the natural gas industry. Levels of salt in fracking water can be more than six times higher than in sea water.

### SUMMARY OF THE INVENTION

A broad aspect of the invention relates to separation of usable water from a stream of water containing hydrophilic, or water soluble, contaminants. In some exemplary embodiments of the invention, the stream is an effluent from an industrial process and the usable water is sufficiently purified to be re-used in the same industrial process.

One aspect of some embodiments of the invention relates to a contact between a bi-directional solvent and a wastewater stream to recover usable water.

Another aspect of some embodiments of the invention relates to recovery and re-use of a bi-directional solvent after said contact between said bi-directional solvent and said wastewater stream and re-use of the recovered solvent in treatment of the wastewater stream.

Another aspect of some embodiments of the invention relates to integration of membrane separation into a water purification process and/or into a solvent recycling process.

As used in this specification and the accompanying claims the term “bi-directional solvent” indicates an organic solvent and/or amine which dissolves in water at least 2% and less than 50% (W/W) and in which water dissolves at least 10% and less than 50% (W/W) at a same temperature or a mixture of two or more such solvents.

Examples of bi-directional solvents include, but are not limited to alcohols of 3 to 6 carbons and/or ketones of 3 to 6 carbons and/or esters of 3 to 6 carbons and/or organic acids of 3 to 6 carbons and amines. In some embodiments, the bi-directional solvent includes butanol. In some embodiments, butanol is the primary active component in a mixture of bi-directional solvents. In some embodiments, butanol serves as the sole active bi-directional solvent. Alternatively or additionally, in some embodiments one or more bi-directional solvents are provided as an extractant. Optionally, the extractant includes components which are not bi-directional solvents. According to an embodiment, the extractant comprises water.

In some exemplary embodiments of the invention, the contacting occurs at a first temperature (T₁) and then adjusting to a second temperature (T₂) is conducted. In some exemplary embodiments of the invention, T₁>T₂. In other exemplary embodiments of the invention, T₂>T₁. In some exemplary embodiments of the invention, T₁ is within 20, 25, 30, 35 or 40° C. of a critical temperature of the bi-directional solvent and water.

As used in this specification and the accompanying claims the terms “solvent-water critical solution temperature” or “solvent-water critical temperature” or “critical solution temperature” or “critical temperature” each indicate the point at which a particular solvent and water become fully miscible in one another in the absence of a third component. In some exemplary embodiments of the invention, the solvent-water critical solution temperature is a lower critical solution temperature. In other exemplary embodiments of the invention, the solvent-water critical solution temperature is an upper critical solution temperature.

Another aspect of some embodiments of the invention relates to recovery of usable water from the contaminated wastewater stream without solidification (e.g. precipitation and/or crystallization) of contaminants.

According to various exemplary embodiments of the invention a water stream to be treated includes one or more hydrophilic solutes and optionally one or more crude-oil-associated hydrophobic solutes.

According to various exemplary embodiments of the invention, the term “hydrophobic solute” indicates organic compounds with C:O atom ratio greater than 3.

One aspect of some embodiments of the invention relates to treatment of a waste water stream containing both hydrophilic solutes and hydrophobic solutes. In some exemplary embodiments of the invention, the hydrophobic solutes are crude-oil-associated.

As used in this specification and the accompanying claims the terms “wastewater stream” can indicate a stream including outflow from an industrial process. In some embodiments, a wastewater stream includes outflow from an industrial process mixed one or more other streams (e.g. make-up water). In some embodiments, the make-up water includes brackish water or sea water.

As used in this specification and the accompanying claims the term “crude-oil-associated” indicates materials present in crude oil (e.g. unrefined petroleum), materials produced during refining of crude oil or chemical conversion of crude oil, materials present in produced gas, materials produced during refining of produced gas or chemical conversion of produced gas. According to various exemplary embodiments of the invention, the term crude oil includes fossil oil, pyrolysis products and/or vegetable oil (e.g. Palm Oil Mill Effluent—POME). In some embodiments, crude-oil-associated hydrophobic solutes are present in the wastewater stream at concentrations of 10 PPM, 25 PPM, 50 PPM 100 PPM, 200 PPM, 300 PPM, 400 PPM or 500 PPM or intermediate or higher concentrations.

As used in this specification and the accompanying claims, the terms “distillation” and “evaporation” are used interchangeably.

As used in this specification and the accompanying claims, the terms “water-depleted” and “water-enriched” mean containing less water and more water, respectively, compared with the content prior to contacting, in terms of amount or flux (rather than in terms of concentration).

In some exemplary embodiments of the invention there is provided a method including: (a) first contacting at least a portion of a wastewater stream including one or more hydrophilic solutes and one or more crude-oil-associated hydrophobic solutes with an extractant including a bi-directional solvent at a first temperature (T₁) within 40° C. of the solvent-water critical temperature to form a water-depleted first aqueous solution and a water-enriched first organic phase; (b) adjusting the temperature of the first organic phase to a second temperature (T₂), to form a second organic phase and a second aqueous solution; wherein the absolute value of (T₂−T₁) is at least 20; (c) separating at least a portion of the one or more crude-oil-associated hydrophobic solutes from the second organic phase; and (d) recycling bi-directional solvent from the second organic phase to the first contacting. In some embodiments, the method includes separating water from the second aqueous solution to form a concentrated aqueous solution and separated water. Alternatively or additionally, in some embodiments the separating water includes contacting the second aqueous solution with a membrane to form a permeate and a retentate and wherein the retentate includes the concentrated aqueous solution. Alternatively or additionally, in some embodiments the membrane is a reverse osmosis membrane. Alternatively or additionally, in some embodiments the retentate separates into a concentrated aqueous solution and a third organic phase. Alternatively or additionally, in some embodiments the method includes recycling at least a portion of the third organic phase to the first contacting. Alternatively or additionally, in some embodiments the permeate includes at least 60% of the water in the wastewater stream. Alternatively or additionally, in some embodiments the wastewater stream includes at least one multivalent ion and at least one monovalent ion at a multivalent to monovalent ratio R1, the first aqueous solution includes at least one multivalent ion and at least one monovalent ion at a multivalent to monovalent ratio R2, and wherein R2>R1. Alternatively or additionally, in some embodiments the method includes contacting at least a fraction of at least one of the first organic phase and the second organic phase with a hydrophobic solvent, wherein the C:O ratio in the hydrophobic solvent is at least 2 times greater than that ratio in the bi-directional solvent. Alternatively or additionally, in some embodiments the one or more crude-oil-associated hydrophobic solutes comprise at least one member of the group consisting of naphthenic acid, other organic acids including at least 5 carbons, 1,4-dioxane, acetone, bromoform, dibenz(a,h)anthracene, pyridine, phenols and oil. Alternatively or additionally, in some embodiments the method includes separating bi-directional solvent from the second aqueous solution and recycling the separated solvent to the first contacting. Alternatively or additionally, in some embodiments the second organic phase includes at least 85% of the one or more crude-oil-associated hydrophobic solutes in the wastewater stream. Alternatively or additionally, in some embodiments the water-depleted first aqueous solution includes at least 80% of the one or more hydrophilic solutes in the wastewater stream. Alternatively or additionally, in some embodiments the method includes recycling at least 50% of water from the wastewater stream to an industrial process producing the wastewater stream. Alternatively or additionally, in some embodiments the wastewater stream is produced by an industrial process selected from the group consisting of induced hydraulic fracturing (fracking), crude oil production from oil sand, a cooling tower, petroleum industry processing, enhanced oil recovery (EOR), Steam Assisted Gravity Drainage (SAGD), pyrolysis process and vegetable oil production. Alternatively or additionally, in some embodiments the method includes producing the wastewater stream by an industrial process selected from the group consisting of recovering crude oil and processing crude oil. Alternatively or additionally, in some embodiments the method includes producing the wastewater stream by contacting crude oil with at least one of the second aqueous solution and the separated water. Alternatively or additionally, in some embodiments the bi-directional solvent includes one or more organic molecules with 3 to 6 carbon atoms. Alternatively or additionally, in some embodiments the organic molecules comprise one or more members of the group consisting of alcohols, ketones, esters and organic acids. Alternatively or additionally, in some embodiments the bi-directional solvent is a butanol. Alternatively or additionally, in some embodiments the bi-directional solvent is a phenol. Alternatively or additionally, in some embodiments the bi-directional solvent has a solvent-water critical temperature in a range between 0° C. and 200° C. Alternatively or additionally, in some embodiments the bi-directional solvent includes one or more amines. Alternatively or additionally, in some embodiments the one or more amines comprise one or more members of the group consisting of diethylamine, triethylamine, 1-methyl piperidine, 4-methyl piperidine di-isopropylamine, N,N-dietheylmethylamine, dimethylisopropylamine, ethylisopropylamine, methylethylisopropylamine, methylethyl-n-propylamine, dimethyl-secondary-butylamine, dimethyl-tertiary-butylamine, dimethylisobutylamine, dimethyl-n-butylamine, methyldiethylamine, dimethylallylamine, dimethyl-n-propylamine, diisopropylamine, di-n-propyl amine, di-allylamine, n-methyl-n-amylamine, n-ethyl-n-butylamine, n-ethyl-sec-butylamine, n-ethyl-tertiary-butylamine, n-ethyl-n-pro pylamine, n-ethyl-isopropylamine, n-methyl-n-butylamine, n-methyl-sec-butylamine, n-methyl-iso-butylamine, n-methyl-tertiary butylamine,dimethyl, 1,1-dimethylpropylamine and dimethyl, 1-methyl butylamine. Alternatively or additionally, in some embodiments the ratio of the one or more hydrophilic solutes to the one or more crude-oil-associated hydrophobic solutes is at least ten times higher in the water-depleted first aqueous solution than in the wastewater stream. Alternatively or additionally, in some embodiments the concentration of at least one of the one or more crude-oil-associated hydrophobic solutes in the extractant is at least three times higher than the concentration of the at least one of the one or more crude-oil-associated hydrophobic solutes in the wastewater stream just prior to the first contacting. Alternatively or additionally, in some embodiments the separating at least a portion of the one or more crude-oil-associated hydrophobic solutes from the second organic phase includes evaporation. Alternatively or additionally, in some embodiments the method includes conducting the first contacting in a counter current mode. Alternatively or additionally, in some embodiments the ratio between the amount of the bi-directional solvent and the amount of water in the wastewater stream at the first contacting is in a range between 2:1 and 20:1. Alternatively or additionally, in some embodiments the ratio between the amount of the bi-directional solvent and the amount of water in the wastewater stream at the first contacting is ≦10:1. Alternatively or additionally, in some embodiments the one or more crude-oil-associated hydrophobic solutes comprise one or more phenols. Alternatively or additionally, in some embodiments the one or more crude-oil-associated hydrophobic solutes comprise one or more oils. Alternatively or additionally, in some embodiments the wastewater stream includes water streams from at least two sources. Alternatively or additionally, in some embodiments the method includes mixing the water streams prior to the first contacting or simultaneously with it. Alternatively or additionally, in some embodiments at least one of the sources is make-up water. Alternatively or additionally, in some embodiments the method comprises using the water-depleted first aqueous solution to enhance oil recovery (e.g. in EOR).

In some exemplary embodiments of the invention there is provided a system including: (a) a first water extraction module adapted to contact an extractant including a bi-directional solvent with at least a portion of a wastewater stream including one or more hydrophilic solutes and one or more crude-oil-associated hydrophobic solutes at a first temperature (T₁) within 40° C. of the solvent-water critical temperature, to form a water-depleted first aqueous solution and a water-enriched first organic phase; (b) a temperature adjustment module adapted to adjust the temperature of the first organic phase to a second temperature (T₂), to form a second organic phase and a second aqueous solution; wherein the absolute value of (T₂−T₁) is at least 20; and (c) a first separation module adapted to separate at least a portion of the one or more crude-oil-associated hydrophobic solutes from the second organic phase. In some embodiments, the system includes a re-circulation module adapted to recycle at least a portion of the second organic phase as bi-directional solvent to the first water extraction module. Alternatively or additionally, in some embodiments the system includes a second separation module adapted to separate water from the second aqueous solution to form a concentrated aqueous solution and separated water. Alternatively or additionally, in some embodiments the second separation module includes a membrane which retains a retentate in a retentate compartment and passes through permeate to a permeate compartment. Alternatively or additionally, in some embodiments the membrane is a reverse osmosis membrane. Alternatively or additionally, in some embodiments the retentate compartment includes a separation mechanism adapted to separate a third in spec mention mixer settler. Alternatively or additionally, in some embodiments the system includes a recirculation mechanism adapted to recycle at least a portion of the third organic phase to the first water extraction module. Alternatively or additionally, in some embodiments the system is configured as a portable system.

It will be appreciated that the various aspects described above relate to solution of technical problems associated with production of usable water and/or recycling of water in an industrial process.

Alternatively or additionally, it will be appreciated that the various aspects described above relate to solution of technical problems related to conservation of energy in water purification processes and/or solvent recycling processes. For example, although a wastewater stream can theoretically be treated by evaporating the water, energy consumption would be high due to the required input of latent heat.

Alternatively or additionally, it will be appreciated that the various aspects described above relate to integration of membrane separation into a water purification strategy while sparing the membrane from contact with materials that would shorten its lifetime to a significant degree.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof This term is broader than, and includes the terms “consisting of” and “consisting essentially of” as defined by the Manual of Patent Examination Procedure of the United States Patent and Trademark Office.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) of chemicals and/or contaminants are W/W (weight per weight) unless otherwise indicated. Percentages of solute in solvent (solute concentration) are W/W. In those cases where a portion of a solute precipitates or crystallizes, the weight of solid solute and dissolved solute are both considered in calculating the solute concentration.

As used herein, “a proportion of”, “a concentration of” or “a ratio between” “hydrophobic solute”, “one or more hydrophobic solute”, “at least one of said one or more hydrophobic solute”, “hydrophilic solute”, “one or more hydrophilic solute”, “at least one of said one or more hydrophilic solute”, “monovalent”, “at least one monovalent ion”, “multivalent”, “at least one multivalent ion” and similar phrases are to be taken as specifying a proportion of or a concentration of at least one solute/ion, or the ratio between concentration of a single solute/ion and the concentration of another single solute/ion.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic flow plan of a water recovery process according to an exemplary embodiment of the invention depicting procedures and streams;

FIG. 2 is a schematic representation of a water recovery system according to some exemplary embodiments of the invention.

### DETAILED DESCRIPTION OF EMBODIMENTS

Embodiments of the invention relate to methods and systems for water recovery as well as to various streams produced by the recovery process. In some exemplary embodiments of the invention, an organic phase containing water is produced during treatment of a wastewater stream, water is separated from the organic phase, and recovered organic solvent is re-used to treat the waste water stream.

Alternatively or additionally, some embodiments of the invention can be used to recover useable water from a waste water stream (e.g. resulting from an industrial process). Optionally, the useable water is re-used in the industrial process which creates the waste water stream.

The principles and operation of a methods and/or systems according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Water Recovery Process Overview

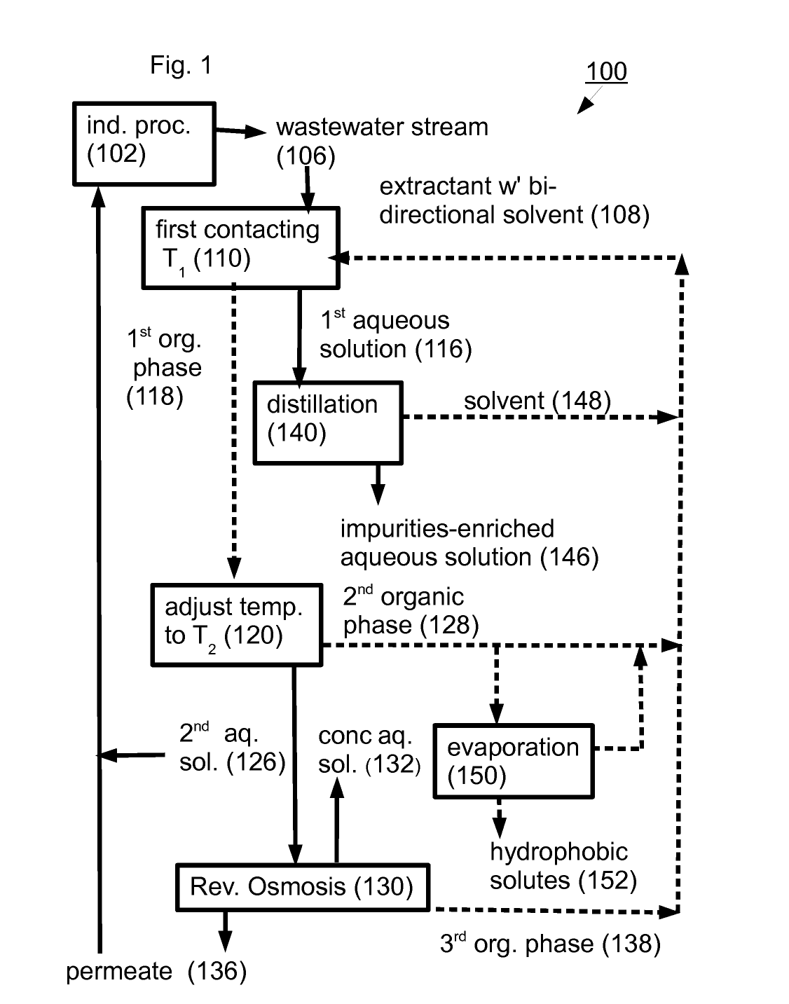

FIG. 1 is a schematic flow plan of a process or method according to an exemplary embodiment of the invention indicated generally as 100. Method 100 recovers clean water (e.g. permeate 136) from a wastewater stream 106 and/or recycles bi-directional solvent (e.g. stream 108) as explained hereinbelow.

In the figures, a flow of organic phases is depicted by dashed arrows, and a flow of aqueous phases is depicted by solid arrows.

In the depicted exemplary embodiment, at least a portion of a wastewater stream 106 containing one or more hydrophilic solutes and one or more crude-oil-associated hydrophobic solutes 106 is first contacted 110 with an extractant including a bi-directional solvent 108 at a first temperature (T₁) within 40° C. of the solvent-water critical temperature to form a water-depleted first aqueous solution 116 and a water-enriched first organic phase 118. In some embodiments, waste water stream 106 results from industrial process 102. According to various exemplary embodiments of the invention industrial process 102 includes one or more of induced hydraulic fracturing (fracking), crude oil production from oil sand, a cooling tower, petroleum industry processing, enhanced oil recovery (EOR), Steam Assisted Gravity Drainage (SAGD), pyrolysis process and vegetable oil production. In the depicted exemplary embodiment, the temperature of first organic phase 118 is adjusted 120 to a second temperature (T₂), to form a second organic phase 128 and a second aqueous solution 126. In some embodiments, the absolute value of (T₂−T₁) is at least 20.

In the depicted exemplary embodiment, bi-directional solvent 108 is recycled from second organic phase 128 to first contacting 110.

In the depicted exemplary embodiment, the wastewater stream 106 comprises one or more crude-oil-associated hydrophobic solutes. According to various embodiments of the invention, at least a portion of the one or more crude-oil-associated hydrophobic solutes is separated from the second organic phase 128 (in the depicted exemplary embodiment, by evaporation 150). According to various exemplary embodiments of the invention the separating hydrophobic solutes 152 is conducted prior to the recycling of bi-directional solvent from the second organic phase 128 to the first contacting 110 or simultaneously with it.

In the depicted exemplary embodiment, water is separated from the second aqueous solution 126 (e.g. by a Reverse Osmosis membrane 130) to form a concentrated aqueous solution 132 (retentate) and separated water (depicted as permeate 136).

In the depicted exemplary embodiment, second aqueous solution 126 contains small amounts of residual organic solvent. According to this embodiment, when solution 126 is filtered by membrane 130 only water passes through as permeate. Thus, the concentration of salts in the retentate increases while the volume of water decreases. Either or both of these changes in retentate composition contribute to a tendency of third organic phase 138 to separate from solution 132.

According to some embodiments of the invention, the concentrated aqueous solution 132 is more concentrated in hydrophobic solutes than second aqueous solution 126. According to various embodiments, the concentrated aqueous solution 132 is disposed as such or after further treatment.

In some exemplary embodiments of the invention, water partial vapor pressure at 50° C. of wastewater stream 106 and water-depleted first aqueous solution 116 are P1 and P2, respectively and P1>P2.

According to some embodiments of the invention, adjusting 120 is conducted on at least a fraction of first organic phase 118.

In some exemplary embodiments of the invention, adjustment to T₁ occurs after first contacting 110. In other exemplary embodiments of the invention, stream 106 and/or extractant 108 are heated or cooled so that contacting brings 106 and 108 to T₁. T₁ is selected to be relatively close to a solvent-water critical temperature so that water from stream 106 will dissolve in extractant 108. According to various exemplary embodiments of the invention relatively close to a critical temperature of the system indicates within 40° C., 35° C., 30° C., 25° C., 20° C., 15° C., 12° C., 10° C. or 8° C. of the critical temperature.

In the depicted exemplary embodiment, first organic phase 118 is adjusted to second temperature 120 (T₂). According to various exemplary embodiments of the invention the absolute value of (T₂−T₁) is at least 10, at least 20, least 30, at least 40, least 50 or at least 60 or intermediate or greater values. Second temperature (T₂) in 120 is markedly different from the critical temperature. According to various exemplary embodiments of the invention (T₂) is at least 35° C.; at least 40° C., at least 45° C., at least 50° C., at least 55° C., or at least 60° C. from the critical temperature of the system at 110. In some exemplary embodiments of the invention, (T₂)<(T₁). In other exemplary embodiments of the invention, (T₂)>(T₁).

In the depicted exemplary embodiment, adjustment to (T₂) produces a second organic phase 128 and a second aqueous solution 126. Because the solvent is a bi-directional solvent, second aqueous solution 126 contains a small amount of solvent and second organic phase 128 contains a small amount of water. However the relative amounts of water in solvent and of solvent in water are lower in this second separation because it is conducted at (T₂).

Alternatively or additionally, in some embodiments, method 100 includes adjusting the temperature of said first organic phase 118 to a third temperature (T₃); wherein the absolute value of (T₃−T₁) is less than 20. According to these embodiments, the temperature of first organic phase 118 is slightly changed in a direction leading to rejection of a small amount of the extracted water, along with a significant amount of the co-extracted salt (hydrophilic solutes). After separation of the rejected water and salt, the temperature of the formed organic phase is adjusted to T₂. According to some embodiments, the rejected water is recycled to the first contacting 110.

In the depicted exemplary embodiment, the two phase system resulting from contacting 110 is separated to produce a water-depleted first aqueous solution 116 and a water-enriched first organic phase 118. Because the solvent is a bi-directional solvent, water-depleted first aqueous solution 116 contains solvent and first organic phase 118 contains water. In some exemplary embodiments of the invention, first aqueous solution 116 is substantially free of organic compounds other than the bi-directional solvent. These organic compounds (crude-oil-associated hydrophobic solutes) tend to migrate into first organic phase 118. As described below, additional separations by evaporation (150) lead to regeneration of the bi-directional solvent and (optionally) to recovery of desired organic compounds (e.g. at 152).

Depicted exemplary embodiment 100 employs distillation 140 to recover bi-directional solvent 148 dissolved in first aqueous solution 116. In other exemplary embodiments of the invention other separation methods are employed, e.g. salting out or using an auxiliary solvent. The amount of solvent 148 to be distilled is relatively small because the majority of bi-directional solvent from extractant 108 is present in first organic phase 118. In some embodiments, solvent 148 distills as an azeotrope with water.

In the depicted exemplary embodiment, distillation 140 also produces an impurities-enriched aqueous solution 146. According to various embodiments, impurities-enriched solution 146 is disposed of as such or after further treatment. According to various embodiments, such further treatment comprises at least one of further concentration, precipitation of at least one component and addition of a chemical compound. According to various embodiments the flow rate of wastewater stream 106 is F1, the flow rate of impurities-enriched solution 146 is F2 and F1/F2 is greater than 2, 4, 6, 8, 10 or intermediate of greater ratio.

In some exemplary embodiments, second organic phase 128 (containing some water) is recycled to extractant stream 108 without further separation of water.

Separated water (depicted as permeate 136) is one product of method 100. In some exemplary embodiments of the invention, the amounts of bi-directional solvent and/or hydrophilic solutes and/or hydrophobic solutes in permeate 136 are sufficiently low at this stage that the permeate can serve as feed water to an industrial process 102 (as indicated by arrows) and/or agricultural irrigation water and/or potable water.

In some exemplary embodiments of the invention, wastewater stream 106 contains one or more crude-oil-associated hydrophobic solutes. These hydrophobic solutes migrate to the bi-directional solvent and will tend to accumulate there if not removed. In the depicted exemplary embodiment, evaporation 150 is depicted as separating at least a portion of the one or more hydrophobic solutes 152 from second organic phase 128 prior to the contacting with wastewater stream 106. In some embodiments, hydrophobic solutes 152 include organic acids (e.g. naphthenic acid).

Alternatively or additionally, in some embodiments, method 100 includes separating second aqueous solution 126 to separated water (depicted as permeate 136) and concentrated aqueous solution 132.

According to various embodiments, water separating from second aqueous solution 126 includes at least one of evaporations, Reverse Osmosis, electrodialysis and contacting with a solvent. In some exemplary embodiments of the invention, the separating of water from second aqueous solution 126 includes contacting the second aqueous solution 126 with a membrane to form a permeate 136 and a retentate which includes the concentrated aqueous solution 132. In the depicted exemplary embodiment, the membrane is a reverse osmosis membrane (RO). In other exemplary embodiments, the membrane is a nano-filtration membrane.

According to some embodiments, second aqueous solution 126 includes the bi-directional solvent. In some embodiments, the concentration of hydrophilic solutes (e.g. salts) contributes to a concentration of the bi-directional solvent in second aqueous solution 126. According to various embodiments, the bi-directional solvent is separated from second aqueous solution 126 by evaporation and/or membrane separation (e.g. Reverse Osmosis) and/or electrodialysis, and recycled to first contacting 110. According to some embodiments, the bi-directional solvent is at least partially removed from the second aqueous solution 126 prior to the contacting with the membrane (depicted as Reverse Osmosis 130), e.g. by distillation. Alternatively or additionally, according to some embodiments the bi-directional solvent is separated by the contacting with a membrane (e.g. Reverse Osmosis membrane 130). According to an embodiment, the bi-directional solvent is rejected by the membrane and is retained in the retentate along with the concentrated aqueous solution 132. In some embodiments, concentrated aqueous solution 132 is of reduced volume and higher salt concentration compared to second aqueous solution 126. As a result, the amount of bi-directional solvent dissolved in it is small compared with the amount dissolved in second aqueous solution 126 and the vast majority of the bi-directional solvent is rejected to a third organic phase 138, which separates from the retentate at 130. In some exemplary embodiments of the invention, third organic phase 138 separates easily from solution 132.

In some embodiments, at least a portion of the third organic phase 138 is recycled as bi-directional solvent to the first contacting 110. According to some embodiments, third organic phase 138 is combined with second organic phase 128 or introduced separately to first contacting 110, e.g. at a point closer to the exit of first aqueous solution 116. Thus, according to some embodiments, first contacting 110 operates in a counter-current mode using a battery of mixer-settlers, and wastewater stream 106 is introduced into a mixer-settler in one end and exists through a mixer settler on the other end (Exit). According to an embodiment, third organic phase 138 is introduced to the exit mixer-settler, while second organic phase 128 is introduced to one of the preceding mixer-settlers.

According to other embodiments, first contacting 110 is operates in a counter-current mode using an extraction column, and wastewater stream 106 is introduced at the top of the column. According to this embodiment, the third organic phase 138 is introduced at the bottom of the column and second organic phase 128 is introduced at a higher point in the column.

In some embodiments, the permeate 136 comprises at least 60%, 70%, 80%, 85%, 90% or at least 95% of the water in the wastewater stream 106.

According to various embodiments, the third organic phase 138 includes the bi-directional solvent and water. According to an embodiment, the third organic phase could be recycled as such to the first contacting in 110.

According to various embodiments, water extraction (first contacting 110) is selective to water over ions. Selectivity is particularly high compared to extraction of divalent ions, including ones contributing to hardness and scale. According to various embodiments, a fraction of the ions in the wastewater 106 are co-extracted with water in said first contacting 110 and are contained in stream 118.

According to some embodiments, wastewater stream 106 includes at least one multivalent ion and at least one monovalent ion at a multivalent to monovalent ratio R1, the first aqueous solution 116 includes at least one multivalent ion and at least one monovalent ion at a multivalent to monovalent ratio R2, and R2>R1. According to some embodiments, R2/R1 is greater than 2, 4, 6, 8 or greater than 10. According to an embodiment, said monovalent ion is selected from a group consisting of sodium, potassium and chloride. According to an embodiment, said multivalent ion is selected from a group consisting of calcium, magnesium and sulfate.

### Exemplary Water Recovery Method

Alternatively or additionally, in some embodiments, method 100 includes contacting (not depicted) at least a fraction of at least one of first organic phase 118 and second organic phase 128 with a hydrophobic solvent, characterized in that C:O ratio in the hydrophobic solvent is at least 2 times greater than that ratio in the bi-directional solvent. According to these embodiments, the contacting induces water rejection from the first organic phase 118 and/or the second organic phase 128. According to various embodiments, after separating the rejected water, the hydrophobic solvent is separated (e.g. by distillation of one of the two) from the bi-directional solvent in first organic phase 118 and/or second organic phase 128 before the bi-directional solvent is reused in the first contacting 110.

According to various exemplary embodiments of the invention crude-oil-associated hydrophobic solutes 152 include naphthenic acid and/or other organic acids comprising at least 5 carbons, and/or 1,4-dioxane, and/or acetone, and/or bromoform, and/or dibenz(a,h)anthracene, and/or pyridine, and/or phenols and/or oil (e.g. fossil oil, vegetable oil). According to some embodiments, in addition to soluble crude-oil-associated hydrophobic matter, there could be suspended crude-oil-associated hydrophobic matter. Therefore, the amount of the crude-oil-associated hydrophobic matter in 106 may be greater than saturation concentration. In some embodiments, the one or more crude-oil-associated hydrophobic solutes comprise one or more phenols. Alternatively or additionally, in some embodiments the one or more crude-oil-associated hydrophobic solutes comprise one or more oils.

According to some embodiments, one or more of the crude-oil-associated hydrophobic solutes is less volatile than water, and is difficult to separate from the wastewater stream 106 by known methods, such as evaporation. According to some embodiments of the invention, such solutes are efficiently removed at low cost, optionally without their evaporation.

In some embodiments, second organic phase 128 includes at least 85%, at least 90%, at least 95%, at least 97.5% or at least 99% of the at least one of the one or more crude-oil-associated hydrophobic solutes which were present in the wastewater 106. Alternatively or additionally, in some embodiments water-depleted first aqueous solution 116 includes at least 80%, at least 85%, at least 90%, at least 95%, at least 97.5% or at least 99% of the at least one of the one or more hydrophilic solutes (i.e. in case of multiple solutes, this could be true for one of the solutes in some embodiments and more than one of them in other embodiments) in the wastewater stream 106.

In some exemplary embodiments of the invention, the method includes recycling at least 50%, at least 55%, at least 65%, at least 70%, at least 75%, at least 80%, at least 85%, at least 90% or at least 95% of water from the wastewater stream 106 to an industrial process producing the wastewater stream. According to some embodiments, the recycled water is derived from the second aqueous solution 126. Alternatively or additionally, according to some embodiments, the recycled water includes the separated water (depicted as permeate 136 from the Reverse Osmosis treatment). According to some embodiments, the industrial process generates different “product process water” stream (i.e. wastewater stream) and/or consumes water/aqueous solutions in multiple steps. According to some embodiments, the recycled water results from any stream and is used in any step. According to some embodiments, the recycled water is at of low impurities content, e.g. impurities content that is 5 times, 10 times, 20 times 50 times or 100 times smaller than that in the wastewater stream. According to some exemplary embodiments, the recycled water is at quality as required for steam production (including steam required for stripping solvent from exiting streams). Alternatively or additionally, according to some embodiments, the water derived from the second aqueous solution 126 and/or from permeate 136 has alternative outlets (e.g. irrigation, emission to rivers and sewage).

According to various exemplary embodiments of the invention the wastewater stream 106 is produced by an industrial process selected from the group consisting of induced hydraulic fracturing (fracking), crude oil production from oil sand, a cooling tower, petroleum industry processing, enhanced oil recovery (EOR) , Steam Assisted Gravity Drainage (SAGD), pyrolysis process and vegetable oil production. In some exemplary embodiments of the invention, wastewater stream 106 is produced by an industrial process selected from the group consisting of recovering crude oil, recovering gas, and processing crude oil.

In some embodiments, method 100 includes producing wastewater stream 106 by an industrial process selected from the group consisting of recovering crude oil and processing crude oil.

In some exemplary embodiments of the invention, method 100 includes contacting (depicted as 102) crude oil with at least one of second aqueous solution 126 and separated water derived from second aqueous solution 126 (depicted as permeate 136) to produce the wastewater stream 106 as indicated by arrows in FIG. 1.

According to some embodiments, water from one or more sources is input to industrial process 102 which produces waste stream 106. According to some embodiments of method 100 produces useable water/recycled water (depicted as 126 and/or 136) from stream 106. In some embodiments, useable water/recycled water (126 and/or 136) returns to industrial process 102.

According to various exemplary embodiments of the invention, the bi-directional solvent in extractant 108 includes one or more organic molecules with 3 to 6 carbon atoms. In some embodiments, the organic molecules include alcohols and/or ketones and/or esters and/or organic acids. In some embodiments, the bi-directional solvent in extractant 108 is a butanol (e.g. n-butanol or isobutanol).

Alternatively or additionally, in some embodiments the bi-directional solvent in extractant 108 is a phenol.

Alternatively or additionally, in some embodiments the bi-directional solvent in extractant 108 has a solvent-water critical temperature in a range between 0 and 200° C., between 10 and 190° C., between 20 and 180° C., between 30 and 170° C., between 40 and 160° C. or between 50 and 150° C.

Alternatively or additionally, in some embodiments the bi-directional solvent in extractant 108 comprises one or more amines. According to some embodiments, the one or more amines include one or more members of the group consisting of diethylamine, triethylamine, 1-methyl piperidine, 4-methyl piperidine di-isopropylamine, N,N-dietheylmethylamine, dimethylisopropylamine, ethylisopropylamine, methylethylisopropylamine, methylethyl-n-propylamine, dimethyl-secondary-butylamine, dimethyl-tertiary-butylamine, dimethylisobutylamine, dimethyl-n-butylamine, methyldiethylamine, dimethylallylamine, dimethyl-n-propylamine, diisopropylamine, di-n-propyl amine, di-allylamine, n-methyl-n-amylamine, n-ethyl-n-butylamine, n-ethyl-sec-butylamine, n-ethyl-tertiary-butylamine, n-ethyl-n-pro pylamine, n-ethyl-isopropylamine, n-methyl-n-butylamine, n-methyl-sec-butylamine, n-methyl-iso-butylamine, n-methyl-tertiary butylamine, dimethyl, 1,1-dimethylpropylamine and dimethyl, 1-methyl butylamine.

In some exemplary embodiments of the invention, a single amine is employed. In other exemplary embodiments of the invention, a combination of two or more amines is employed. Alternatively or additionally, amines are used in combination with non-amine molecules in some embodiments of the invention.

In some exemplary embodiments of the invention, the ratio of at least one of the hydrophilic solutes to at least one of the crude-oil-associated hydrophobic solutes is at least ten times higher (this ratio does not necessarily apply to the ratio between total hydrophilic solutes and total hydrophobic solutes) in the water-depleted first aqueous solution 116 than in the wastewater stream 106.

Alternatively or additionally, in some embodiments of the invention, the concentration of at least one of the one or more crude-oil-associated hydrophobic solutes in extractant 108 is at least three times higher than the concentration of the at least one of the one or more crude-oil-associated hydrophobic solutes in the wastewater stream 106 just prior to first contacting 110 (this ratio does not necessarily apply to the total hydrophobic solutes).

In the depicted exemplary embodiment, separating at least a portion of the one or more crude-oil-associated hydrophobic solutes 152 from second organic phase 128 includes evaporation 150. In some exemplary embodiments of the invention, evaporation 150 includes distillation of the solvent from solutes 152. According to some embodiments, the hydrophobic solute is more volatile than the bi-directional solvent. In that case, the solute is evaporated out. In other cases, the bi-directional solvent is more volatile than said hydrophobic solute and the bi-directional solvent is evaporated. Still there could be both solutes that are more volatile than the bi-directional solvent and ones that are less volatile. In such cases, the more volatile are evaporated first and then the bi-directional solvent is evaporated. According to an embodiment, only a small fraction of the second organic phase 128 is treated for separation of the hydrophobic solutes 152, e.g. less than 20% of it, less than 15%, less than 10%, or less than 5%.

In some embodiments the one or more crude-oil-associated hydrophobic solutes include one or more phenols. Alternatively or additionally, in some embodiments the one or more crude-oil-associated hydrophobic solutes include one or more oils (e.g. fossil oil, vegetable oil).

In some embodiments, the method includes conducting first contacting 110 in a counter current mode. According to some embodiments, the first contacting 110 is conducted in 2-20 stages, 3-15 stages, 4-12 stages or 5-10 stages.

Alternatively or additionally, in some embodiments the method includes washing first organic phase 118 with water (not depicted). In some embodiments, this washing is conducted at T₁. Optionally, washing removes additional salts prior to adjusting to T₂. In some embodiments, the washing is conducted with a small stream of water or diluted solution (e.g. of a volume between 1-10% of the first organic phase 118). According to some embodiments, the washing forms an aqueous wash solution and washed first organic phase. The temperature of the washed first organic phase is then adjusted to T₂. According to an embodiment, the aqueous wash solution is recycled to first contacting 110.

Alternatively or additionally, in some embodiments of method 100 the weight/weight ratio between the amount of bi-directional solvent in stream 108 and the amount of water in stream 106 at first contacting 110 is in a range between 2:1 and 20:1, between 3:1 to 17:1, between 6:1 to 15:1 or in a range between 8:1 to 12:1. Alternatively or additionally, in some embodiments the weight/weight ratio between the amount of bi-directional solvent in stream 108 and the amount of water in stream 106 at first contacting 110 is <10:1, <8:1, <6:1, <4:1 or ≦2:1. According to some embodiments, first contacting 110 is conducted in a continuous mode and this ratio is between the weight fluxes of streams instead of the amounts.

In some embodiments, stream 106 contains suspended solids. These solids can include, but are not limited to sand or soil particles. According to various embodiments, these solids are removed prior to the first contacting 110. According to various exemplary embodiments of the invention solids removal module includes a settling tank and/or filtration equipment and/or centrifugation equipment (e.g. a flow through centrifuge and/or a cyclonic separator). In some embodiments, removal of solids contributes to mechanical efficiency of downstream processes.

Alternatively or additionally, in some embodiments stream 106 contains one or more dissolved surfactants (e.g. soaps and/or detergents). According to various embodiments, at least one of the one or more surfactants is removed from and/or inactivated in at least a portion of stream 106 prior to first contacting 110. In some embodiments, a surfactant neutralization module is positioned upstream of the first contacting 110 to reduce activity of surfactants present in stream 106. According to various exemplary embodiments of the invention the surfactant neutralization module employs surface active material (e.g. activated charcoal) and/or acidification and/or addition of high concentrations of cations (e.g. divalent cations such as magnesium or calcium).

In those embodiments which employ surface active material, at least a portion of surfactant is physically removed from stream 106 (e.g. by being adsorbed to the material). Alternatively or additionally, in some embodiments at least a portion of the surfactant remains in stream 106 in an inactive form.

In some embodiments, water with a high concentration of inorganic salts is delivered to surfactant neutralization module to neutralize at least a portion of the surfactants in stream 106.

In some exemplary embodiments of the invention, the surfactant neutralization module contributes to an efficiency of separation of first aqueous solution 116 from first organic phase 118 and/or to an efficiency of separation of second aqueous solution 126 from second organic phase 128.

### Exemplary Water Compositions

In some exemplary embodiments of the invention, wastewater stream 106 contains at least 10,000 PPM; at least 20,000 PPM; at least 30,000 PPM; at least 40,000 PPM or at least 50,000 PPM of total dissolved solids (TDS). In other exemplary embodiments of the invention, stream 106 contains less than 100,000 PPM, less than 90,000 PPM, less than 80,000 PPM, less than 70,000 PPM or less than 50,000 PPM of total dissolved solids (TDS).

In various exemplary embodiments of the invention, total dissolved solids (TDS) in said wastewater stream 106 is less than 10,000 ppm; less than 8,000 ppm; less than 6,000 ppm; less than 4,000 ppm or less than 2,000 ppm. Wastewater stream with these relatively low levels of TDS is produced, for example, in cooling towers and/or in the oil industry.

Alternatively or additionally, in some embodiments the TDS includes barium and/or strontium and/or iron and/or other heavy metals and/or radioactive isotopes and/or cyanides and/or thiocyanates and/or salts of ammonia and/or sulfides and/or sulfates and/or calcium salts and/or silica.

### Exemplary Extraction Conditions

Various exemplary embodiments of the invention described herein relate to extraction (110) of water into an extractant comprising bi-directional solvent. According to various embodiments, such extraction is conducted by contacting in a multiple step, counter-current operation. According to various embodiments, such contacting is conducted in industrially used contactors, e.g. mixer-settlers, extraction columns, centrifugal contactors and raining-bucket contactor. According to an embodiment, the wastewater 106 comprises suspended solids and/or solids are formed during said first contacting and the used contactor is designed to handle such solids.

### Exemplary Wastewater Streams

In some embodiments, wastewater stream 106 results from an industrial process 102.

In some exemplary embodiments of the invention, the wastewater stream 106 comprises water streams from at least two sources. According to some embodiments, these streams are mixed prior to first contacting 110 or simultaneously with it. According to other embodiment, these streams are contacted with the extractant 108 at different stages of the extraction in 110. According to some embodiments, at least one of the sources is make-up water.

### Exemplary Optional Treatment of First Organic Phase

In some exemplary embodiments of the invention, first organic phase 118 is treated prior to adjusting 120, e.g. by adding an organic solvent or contacting with an aqueous solution. According to another embodiment, first organic phase 118 comprises suspended solids and said treating prior to said adjusting 120 comprises separating such suspended solids, e.g. via extended settling or addition of a coagulant.

### Exemplary Solvent Considerations

According to various exemplary embodiments of the invention the bi-directional solvent employed in extractant stream 108 is selected based upon the total dissolved solids (TDS) content of stream 106 and/or the organic compounds (e.g. hydrophobic solutes) content of stream 106 and/or the cost of available energy.

### Exemplary System

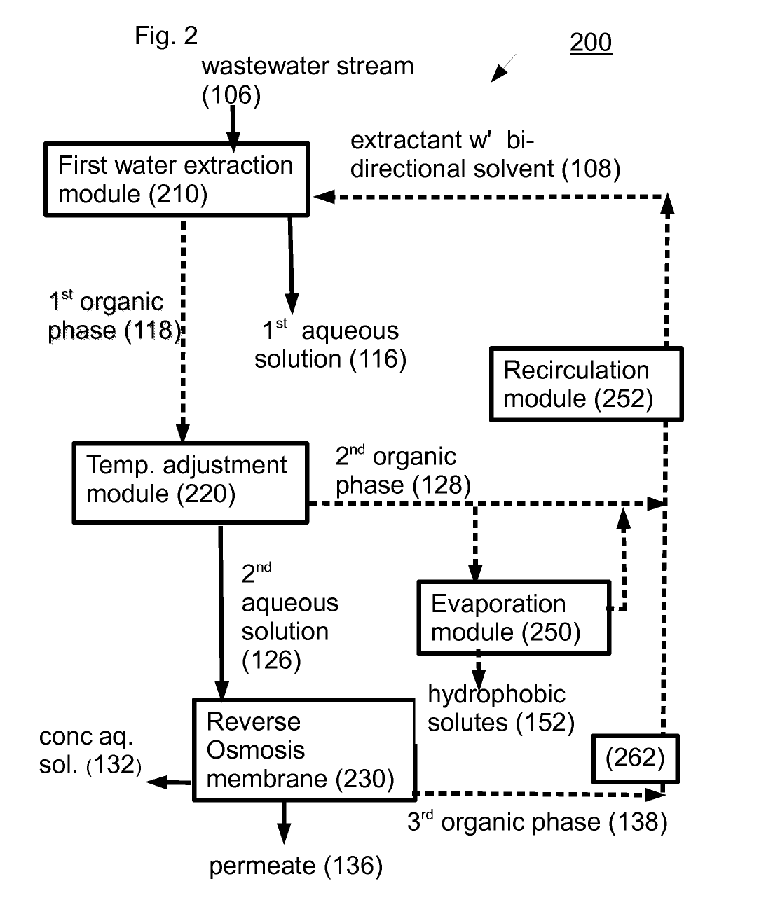

FIG. 2 is a schematic representation of system indicated generally as 200. System 200 can be described as a water recovery and/or a solvent recycling system. In the figure, a flow of organic phases is depicted by dashed arrows, and a flow of aqueous solutions is depicted by solid arrows. Numbers which appear in FIG. 1 and are used in FIG. 2 indicate flows similar to those described above.

Depicted exemplary system 200 includes a first water extraction module 210 adapted to contact an extractant comprising a bi-directional solvent 108 with at least a portion of a wastewater stream 106 including one or more hydrophilic solutes and one or more crude-oil-associated hydrophobic solutes at a first temperature (T₁) within 40° C. of the solvent-water critical temperature, to form a water-depleted first aqueous solution 116 and a water-enriched first organic phase 118.

In the depicted exemplary embodiment, system 200 includes a temperature adjustment module 220 (e.g. heat exchanger and/or flashing module) adapted to adjust the temperature of the first organic phase 118 to a second temperature (T₂), to form a second organic phase 128 and a second aqueous solution 126. In some embodiments, the absolute value of (T₂−T₁) is at least 20.

According to some embodiments, system 200 includes a first separation module (depicted as Evaporation module 250) adapted to separate at least a portion of the one or more crude-oil-associated hydrophobic solutes 152 from second organic phase 128.

Alternatively or additionally, in some embodiments exemplary system 200 includes a second separation module (depicted as Reverse Osmosis membrane 230) adapted to separate a retentate (depicted as concentrated aqueous solution 132) from separated water (depicted as permeate 136) from second aqueous solution 126. According to some embodiments of the invention, the concentrated aqueous solution 132 is more concentrated in hydrophobic solutes than second aqueous solution 126.

Alternatively or additionally, in some embodiments system 200 includes a second separation module (230) adapted to separate water from second aqueous solution 126 to form a concentrated aqueous solution 132 and separated water (permeate 136). According to various exemplary embodiments of the invention separation module 230 employs distillation and/or membrane separation. In the depicted exemplary embodiment, second separation module 230 comprises a membrane which retains a retentate (132 and/or 138) in a retentate compartment and passes through permeate 136 to a permeate compartment. In some embodiments, the retentate includes concentrated aqueous solution 132 and third organic phase 138. In some exemplary embodiments of the invention, the retentate compartment comprises a separation mechanism adapted to separate third organic phase 138 from concentrated aqueous solution 132. In some embodiments, the adaptation includes installation of a mixer/settler.

In some exemplary embodiments of the invention, solution 132 has a high salt concentration. Optionally, this high salt concentration contributes to separation of organic phase 138 from solution 132. Alternatively or additionally, in some embodiments an amount of water in solution 132 is much lower than in solution 126 due to permeation of permeate 136 through membrane 230. Optionally, this reduction in the amount of water contributes to a tendency of organic phase 138 to separate from solution 132.

According to various embodiments, the concentrated aqueous solution 132 is disposed of as such or after further treatment.

In some exemplary embodiments of the invention, adjustment to T₁ occurs after the first contacting in the module 210. In other exemplary embodiments of the invention, stream 106 and/or extractant 108 are heated or cooled so that contacting in module 210 brings 106 and 108 to T₁. T₁ is selected to be relatively close to a solvent-water critical temperature so that water from stream 106 will dissolve in extractant 108. According to various exemplary embodiments of the invention relatively close to a critical temperature of the system indicates within 40° C., 35° C., 30° C., 25° C., 20° C., 15° C., 12° C., 10° C. or 8° C. of the critical temperature.

In the depicted exemplary embodiment, first organic phase 118 is adjusted to second temperature (T₂) at the temperature adjustment module 220. According to various exemplary embodiments of the invention the absolute value of (T₂−T₁) is at least 10, at least 20, least 30, at least 40, least 50 or at least 60 or intermediate or greater values. Second temperature (T₂) in 220 is further from the critical point of the system at 210 (T₁). According to various exemplary embodiments of the invention (T₂) is at least 35° C.; at least 40° C., at least 45° C., at least 50° C., at least 55° C., or at least 60° C. from the critical temperature of the system at 210. In some exemplary embodiments of the invention, (T₂)<(T₁). In other exemplary embodiments of the invention, (T₂)>(T₁).

In the depicted exemplary embodiment, adjustment to (T₂) in 220 produces a second organic phase 128 and a second aqueous solution 126. Because the solvent is a bi-directional solvent, second aqueous solution 126 contains a small amount of solvent and second organic phase 128 contains a small amount of water. However the relative amounts of water in solvent and of solvent in water are lower in this second separation because it is conducted at (T₂).

In some embodiments, system 200 includes a re-circulation module 252 adapted to recycle at least a portion of second organic phase 128 as bi-directional solvent 108 to first water extraction module 210. According to various exemplary embodiments of the invention recirculation mechanism 252 includes a pump and/or connectors and/or conduits (e.g. pipes) which allow its integration into system 200.

In some embodiments, system 200 includes a recirculation mechanism 262 adapted to recycle at least a portion of third organic phase 138 to first water extraction module 210 (e.g. as part of stream 108). According to various exemplary embodiments of the invention recirculation mechanism 262 includes a pump and/or connectors and/or conduits (e.g. pipes) which allow its integration into system 200.

In some embodiments, system 200 is designed and configured as portable system. As used in this specification and the accompanying claims the term “portable” means transportable on one or more trucks. In some exemplary embodiments of the invention, the hardware modules of the system (e.g. 210, 220, 230 and/or 250 and/or 252 and/or 262 are provided on a single truck and a quantity of extractant (e.g. 108) suitable for operation is provided one or more additional trucks (e.g. tanker trucks). In some embodiments, hardware components of the system are provided in standard corrugated metal shipping container so that they can be easily transferred between ships and/or railroad cars and/or trucks. Optionally, such a configuration permits transportation from one place to another (e.g. from one shale oil play or fracking play to another). In other exemplary embodiments of the invention, system 200 (or a portion thereof) is skid mounted.

### Exemplary Advantages

One exemplary advantage of some embodiments of the invention is that water is separated by the extraction with a bi-directional solvent and recovered from the formed organic phase without the input of latent heat.

Alternatively or additionally, another exemplary advantage of some embodiments of the invention is that the membrane (depicted as Reverse Osmosis 130 in FIG. 1 and/or as 230 in FIG. 2) is not directly contacted with wastewater stream 106. In some embodiments, elimination of contact between membrane 130/230 and stream 106 contributes to an increase in membrane life.

Alternatively or additionally, those portions of the process that optionally employ latent heat (e.g. distillation 140 and/or 250) are applied to smaller portions of the total mass in the system, resulting in significant energy savings.

Alternatively or additionally, exemplary method 100 achieves efficient separation of usable water (depicted as permeate 136) from the wastewater (106) forming a reduced-volume, impurities-concentrated stream (impurities-enriched aqueous solution 146), thereby reducing the volume of wastewater to disposal.

Alternatively or additionally, exemplary method 100 achieves good separation of organic matter (hydrophobic solutes 152), which can be used for energy or more specific application.

Alternatively or additionally, exemplary method 100 results in a high quality separated water, which may be used e.g. for steam, in a relatively low costs compared to alternative treatments.

Alternatively or additionally, exemplary methods described herein are more suitable for use in handling hard or scaling water (at 106) than previously available alternatives.

Alternatively or additionally, exemplary methods described herein contribute to a reduction in use of chemical reagents.

Alternatively or additionally, exemplary methods described herein are amenable to integration with other methods, e.g. gravity separation devices such as the API (American Petroleum Institute) oil-water separator.

Exemplary use scenario I: Induced Hydraulic Fracturing (Fracking)

In some exemplary embodiments of the invention, industrial process 102 is fracking

A typical fracking well requires between 4,000 m³ and over 22,000 m³ of water. Waste water produced by fracking contains hydrophilic solutes including but not limited to sodium, magnesium and calcium salts, barium, strontium, iron, other heavy metals, radioactive isotopes. Total dissolved solids (TDS) are typically in the range of 5,000 PPM to 100,000 PPM or more. Conventional treatment of this waste water reduces the TDS to 5000 PPM or less. This treated water is “fresh” and can be used for any purpose. In some exemplary embodiments of the invention, treatment of fracking water reduces TDS to a lower degree (e.g. to 6,000; 7,000 or 8,000 PPM) and the treated water is used for a subsequent round of fracking

Waste water produced by fracking also contains hydrophobic materials such as oil.

Referring again to FIGS. 1 and 2: in some exemplary embodiments of the invention, fracking serves as industrial process 102 and flowback and/or produced water serve as wastewater stream 106.

During water recovery process 100, the bulk of the hydrophilic solutes will separate into first aqueous solution 116 and according to some embodiments, be removed from the system at 146 as described in detail hereinabove.

The hydrophobic solutes are selectively and efficiently extracted into the first organic phase 118 in the first contacting 110. The hydrophobic solutes remain practically fully in the extractant on the adjusting 120, i.e. in the second organic phase 128. In the depicted exemplary embodiment of FIG. 1, a fraction of the hydrophobic solutes arrive at evaporation 150 and is at least partially removed from the system at 152. Separated water (depicted as permeate 136) becomes returns to industrial process 102 as indicated and can be used as part of input water for a subsequent round of fracking

In some cases, waste water produced by fracking contains soap. Optionally, soap is removed prior to introduction into method 100. In some exemplary embodiments of the invention, removal of soap contributes to a more efficient partitioning between organic phases and aqueous solutions throughout the process.

Exemplary use Scenario II: Synthetic Crude Oil from Oil Sand

In some exemplary embodiments of the invention, industrial process 102 is production of synthetic crude oil from sand.

Production of a barrel of synthetic crude oil from oil sand requires about 2 to 4.5 barrels of fresh water as an input. In the conventional subterranean process, this water is applied as steam to oil sand in a well. In the Canadian process, the oil sand is removed from the well and then the water is applied. Waste water produced during production of synthetic crude oil contains inorganic salts (hydrophilic solutes), and organic acids (hydrophobic solutes).

Referring again to FIGS. 1 and 2: in some exemplary embodiments of the invention, production of synthetic crude oil serves as industrial process 102 and wastewater produced during production of synthetic crude oil serves as wastewater stream 106.

During water recovery process 100, the bulk of the hydrophilic inorganic salts will separate into first aqueous solution 116 and according to some embodiments, be removed from the system at 146 as described in detail hereinabove.

The hydrophobic solutes (organic acids) are selectively and efficiently extracted into the first organic phase 118 in the first contacting 110. The hydrophobic solutes remain practically fully in the extractant on the adjusting 120, i.e. in the second organic phase 128. In the depicted exemplary embodiment of FIG. 1, a fraction of the hydrophobic solutes arrive at evaporation 150 and is at least partially removed from the system at 152. Separated water (depicted as permeate 136) returns to industrial process 102 as indicated and can be used as part of input water for a subsequent round of production of synthetic crude oil.

### Exemplary use Scenario III: Cooling Water

In some exemplary embodiments of the invention, industrial process 102 includes cooling towers.

In Israel water-cooled condensers are estimated to consume some 130 million M³ of water each year and discharge 35 million M³ of brines each year. The brines contain about 5.6 tons of chlorides/M³ and about tons of 2.6 tons of sodium/M³.

Since water-cooled condensers are widely used in large public institutions throughout the country, it is estimated that about 50 million M³ of water are consumed each year for air conditioning alone.

Even larger amounts of cooling water are used in an industrial context. As an example, a single refinery can require about 350 M³ /hour of cooling water. Of this amount, about 60 to 80% is lost to evaporation in cooling towers and the remaining 20 to 40% is recovered as cooled water which is, at least theoretically, available for recycling. Because minerals do not evaporate, salts are concentrated in the cooling tower by a factor of about 2.5 to 5.

This means that recycling of cooled water without treatment to remove dissolved minerals will cause an increase in the mineral concentration in water circulating in the cooling system over time.

Referring again to FIGS. 1 and 2: in some exemplary embodiments of the invention, cooling in a cooling tower serves as industrial process 102 and the cooled water serves as wastewater stream 106.

During water recovery process 100, the bulk of the hydrophilic inorganic salts will separate into first aqueous solution 116 and according to some embodiments, be removed from the system at 146 as described in detail hereinabove. Separated water (depicted as permeate 136) becomes returns to industrial process 102 as indicated and can be used as part of input water for a subsequent round of cooling.

Water recovery process 100 is suitable to treat wastewater stream 106 from the oil industry (e.g. refineries) and cooling towers from various industries. In some cases, an oil refinery includes one or more cooling towers so that there are multiple sources of wastewater.

According to various exemplary embodiments of the invention these multiple sources of wastewater are treated according to method 100 either separately or in combination with one another.

Exemplary use Scenario IV: Effluents from Petroleum Industry Processing

In some embodiments, industrial process 102 is a petroleum refinery.

In a petroleum refinery, processing includes various treatments (e.g. cracking, which is the process in which heavy hydrocarbons are broken down to lighter hydrocarbons). These processing treatments produce wastewater streams including hydrophilic solutes. These hydrophilic solutes can include, but are not limited to cyanide salts, thiocyanate salts, salts of ammonia and sulfides (e.g. H₂S). In addition the waste can include hydrophobic solutes such as oils and/or phenols. The phenols can include the monohydrics (having one hydroxyl group) such as phenol; o-, m-, and p-cresols, the various xylenols, and the various ethylphenols. The phenols may also include polyhydrics (having two or more hydroxyl groups) such as catechol and resorcinol which are C₆H₄(OH)₂ isomers. Alternatively or additionally, the phenols may include thiophenols such as benzenethiol (or phenyl mercaptan) which is C₆H₅SH and toluenethiols (or tolyl mercaptans) which are CH₃C₆H₄SH isomers. For example, petroleum industry processing wastewater stream can include ≦50 mg cyanides or thiocyanates and/or ≧500 mg/L ammonia or ammonium salts and/or ≧500 mg/L sulfides as hydrophilic solutes. The same stream may also include 50 to 500 mg/L of phenols and/or 50 to 500 mg/L of oils as hydrophobic solutes.

Referring again to FIGS. 1 and 2: in some exemplary embodiments of the invention, petroleum industry processing serves as industrial process 102 and wastewater produced during the processing serves as wastewater stream 106.

During water recovery process 100, the bulk of the hydrophilic inorganic salts will separate into first aqueous solution 116 and according to some embodiments, be removed from the system at 146 as described in detail hereinabove.

The hydrophobic solutes (phenols and/or oils) are selectively and efficiently extracted into the first organic phase 118 in the first contacting 110. The hydrophobic solutes remain practically fully in the extractant on the adjusting 120, i.e. in the second organic phase 128. In the depicted exemplary embodiment of FIG. 1, a fraction of the hydrophobic solutes arrive at evaporation 150 and is at least partially removed from the returns to industrial process 102 and can be used as part of input water for a subsequent round of any of the processing treatments.

### Exemplary use Scenario V: Enhanced Oil Recovery (EOR)

In some embodiments, industrial process 102 is EOR.

The EOR process is similar production of oil from oil sand (scenario II above) in that it involves pumping water down into a well. In EOR liquid water penetrates oil in the bottom of the well and accumulates underneath the oil. As the water accumulates it raises the oil until the oil reaches a level at which it can be pumped from the well. The oil pumped from the well using EOR contains about 20 to 30% water carrying a high concentration of salts which can contain metals and/or radioisotopes. In order to re-use this water it must be separated from the oil and the salt concentration must be reduced.

Referring again to FIGS. 1 and 2: in some exemplary embodiments of the invention, EOR serves as industrial process 102 and water separated from recovered crude oil serves as wastewater stream 106.

During water recovery process 100, the bulk of the hydrophilic inorganic salts, metals and radioisotopes will separate into first aqueous solution 116 and according to some embodiments, be removed from the system at 146 as described in detail hereinabove.

The hydrophobic solutes (suspended oil droplets) are selectively and efficiently extracted into the first organic phase 118 in the first contacting 110. The hydrophobic solutes remain practically fully in the extractant on the adjusting 120, i.e. in the second organic phase 128. In the depicted exemplary embodiment of FIG. 1, a fraction of the hydrophobic solutes arrive at evaporation 150 and is at least partially removed from the system at 152. Separated water (depicted as permeate 136) returns to industrial process 102 and can be used as part of input water for a subsequent round of EOR.

Additional objects, advantages, and novel features of some embodiments of the invention will become apparent to one ordinarily skilled in the art upon examination of the following example, which is not limiting. Additionally, various embodiments and aspects of the present invention as delineated hereinabove and as claimed in the claims section below find experimental support in the following example.

### EXAMPLE

Reference is now made to the following example, which together with the above descriptions, illustrate the invention in a non limiting fashion.

### EXPERIMENTAL EXAMPLE

A wastewater stream was obtained at ambient temperature and heated to 130° C. The wastewater stream contained 2.3 wt % monovalent salts, 2.2 wt % divalent salts and 50 ppm of organic matter. The wastewater stream was counter-currently extracted with a recycled n-butanol extractant, which was pre-heated to 130° C. The recycled extractant contained 17.2% wt water. Extraction was conducted in a pressure system, which provided 5 actual stages at butanol to wastewater volume/volume flux ratio of 5.7. The existing organic phase was the extract. Water concentration in the extract increased until it reached a steady state at 26.7% wt. This increase in water concentration of the organic phase from 17.2 wt % to 26.7 wt % represents extracting 79% of the water in the wastewater stream. Analysis of the exiting aqueous phase, after removal of dissolved n-butanol, showed extraction of >95% of the organic matter.

A fraction of the steady state extract was cooled to ambient temperature. Two phases were observed. The heavier phase was a dilute aqueous solution. The lighter phase was butanol containing 17.2 wt % water.

In summary, at the selected 0/A ratio and at 130° C., 79% of the water in the wastewater solution was extracted into a recycled butanol extractant. Cooling the formed extract to ambient temperature separated the extracted water and regenerated the extractant. It is expected that during the life of this patent many additional industrial processes and/or de-salination techniques will be developed and the scope of the invention is intended to include all such new technologies a priori.

As used herein the term “about” refers to 10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments not including the recited feature, part, component, module or process exist.

Specifically, the invention has been described in the context of industrial processes and de-salination but might also be used to reduce levels of radioisotopes in water.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-44. (canceled)

45. A method comprising:
(a) first contacting at least a portion of a wastewater stream comprising one or more hydrophilic solutes and one or more crude-oil-associated hydrophobic solutes with an extractant comprising a bi-directional solvent at a first temperature (Tᵢ) within 40° C. of the solvent-water critical temperature to form a water-depleted first aqueous solution and a water-enriched first organic phase;
(b) adjusting the temperature of said first organic phase to a second temperature (T₂), to form a second organic phase and a second aqueous solution; wherein the absolute value of (T₂−T₁) is at least 20;
(c) separating at least a portion of said one or more crude-oil-associated hydrophobic solutes from said second organic phase; and
(d) recycling bi-directional solvent from said second organic phase to said first contacting.

46. A method according to claim 45, comprising separating water from said second aqueous solution to form a concentrated aqueous solution and separated water.

47. A method according to claim 46, wherein said separating water comprises contacting said second aqueous solution with a reverse osmosis membrane to form a permeate and a retentate and wherein said retentate comprises said concentrated aqueous solution.

48. A method according to claim 47, wherein said retentate separates into a concentrated aqueous solution and a third organic phase.

49. A method according to claim 48, comprising recycling at least a portion of said third organic phase to said first contacting.

50. A method according to claim 45, wherein said wastewater stream comprises at least one multivalent ion and at least one monovalent ion at a multivalent to monovalent ratio R1, said first aqueous solution comprises at least one multivalent ion and at least one monovalent ion at a multivalent to monovalent ratio R2, and wherein R2>R1.

51. A method according to claim 45, comprising contacting at least a fraction of at least one of said first organic phase and said second organic phase with a hydrophobic solvent, wherein a C:O ratio in said hydrophobic solvent is at least 2 times greater than that ratio in said bi-directional solvent.

52. A method according to claim 45, wherein said one or more crude-oil-associated hydrophobic solutes comprise at least one member of the group consisting of naphthenic acid, other organic acids comprising at least 5 carbons, 1,4-dioxane, acetone, bromoform, dibenz(a,h)anthracene, pyridine, phenols and oil.

53. A method according to claim 45, comprising separating bi-directional solvent from said second aqueous solution and recycling said separated solvent to said first contacting.

54. A method according to claim 45, wherein said second organic phase comprises at least 85% of said one or more crude-oil-associated hydrophobic solutes in said wastewater stream.

55. A method according to claim 45, wherein said water-depleted first aqueous solution comprises at least 80% of said one or more hydrophilic solutes in said wastewater stream.

56. A method according to claim 45, wherein said wastewater stream is produced by an industrial process selected from the group consisting of induced hydraulic fracturing (fracking), crude oil production from oil sand, a cooling tower, petroleum industry processing, enhanced oil recovery (EOR), Steam Assisted Gravity Drainage (SAGD), pyrolysis process and vegetable oil production.

57. A method according to claim 45, wherein said bi-directional solvent comprises one or more organic molecules with 3 to 6 carbon atoms.

58. A method according to claim 57, wherein said organic molecules comprise one or more members of the group consisting of alcohols, ketones, phenols, esters and organic acids.

59. A method according to claim 57, wherein said bi-directional solvent is a butanol.

60. A method according to claim 45, wherein said bi-directional solvent has a solvent-water critical temperature in a range between 0° C. and 200° C.

61. A method according to claim 45, wherein the ratio between the amount of said bi-directional solvent and the amount of water in said wastewater stream at said first contacting is in a range between 2:1 and 20:1.

62. A method according to claim 61, wherein the ratio between the amount of said bi-directional solvent and the amount of water in said wastewater stream at said first contacting is ≦10:1.

63. A system comprising:
(a) a first water extraction module adapted to contact an extractant comprising a bi-directional solvent with at least a portion of a wastewater stream comprising one or more hydrophilic solutes and one or more crude-oil-associated hydrophobic solutes at a first temperature (T₁) within 40° C. of the solvent-water critical temperature, to form a water-depleted first aqueous solution and a water-enriched first organic phase;
(b) a temperature adjustment module adapted to adjust the temperature of said first organic phase to a second temperature (T₂), to form a second organic phase and a second aqueous solution; wherein the absolute value of (T₂−T₁) is at least 20; and
(c) a first separation module adapted to separate at least a portion of said one or more crude-oil-associated hydrophobic solutes from said second organic phase.

64. A system according to claim 63, comprising a re-circulation module adapted to recycle at least a portion of said second organic phase as bi-directional solvent to said first water extraction module.

65. A system according to claim 63, comprising a second separation module adapted to separate water from said second aqueous solution to form a concentrated aqueous solution and separated water and wherein said second separation module comprises a reverse osmosis membrane which retains a retentate in a retentate compartment and passes through permeate to a permeate compartment.
